(19) United States
(12) Patent Application Publication
(10) Pub. No.: US 2025/0259114 A1
(43) Pub. Date: Aug. 14, 2025

(54) Sustainable Pipeline Of Pozzolanic Materials

(71) Applicant: Halliburton Energy Services, Inc., Houston, TX (US)

(72) Inventors: Siva Rama Krishna Jandhyala, Houston, TX (US); Fahad Ahmad, Houston, TX (US)

(73) Assignee: Halliburton Energy Services, Inc., Houston, TX (US)

(21) Appl. No.: 18/441,129

(22) Filed: Feb. 14, 2024

(51) Int. Cl. G06N 20/20; G06N 5/022

(52) U.S. Cl. CPC G06N 20/20; G06N 5/022

(57) ABSTRACT

In general, in one aspect, embodiments relate to a method of producing a sustainable pipeline of pozzolanic materials that includes gathering unstructured and/or structured data publicly available on a network, identifying analytical data of a pozzolanic material using one or more machine learning models, where the analytical data is present within at least the structured data, extracting the analytical data from the structured data, predicting, using one or more predictive models, one or more performance characteristics of the pozzolanic material based at least in part on the analytical data, to form one or more predicted performance characteristics, comparing the predicted one or more performance characteristics to one or more minimum acceptable performance characteristics, storing the extracted analytical data and the one or more predicted performance characteristics in a database if the one or more performance characteristics meets or exceeds the minimum acceptable performance characteristic, and preparing a cement composition that includes the pozzolanic material if the predicted one or more performance characteristics meets or exceeds the one or more minimum acceptable performance characteristics.

### BACKGROUND

Cement compositions may be used in a variety of subterranean operations. For example, in subterranean well construction, a pipe string (e.g., casing, liners, expandable tubulars, etc.) may be run into a wellbore and cemented in place. The process of cementing the pipe string in place is commonly referred to as “primary cementing.” In a typical primary cementing method, a cement composition may be pumped into an annulus between the walls of the wellbore and the exterior surface of the pipe string disposed therein. The cement composition may set in the annular space, thereby forming an annular sheath of hardened, substantially impermeable cement (i.e., a cement sheath) that may support and position the pipe string in the wellbore and may bond the exterior surface of the pipe string to the subterranean formation. Among other things, the cement sheath surrounding the pipe string prevents the migration of fluids in the annulus and protects the pipe string from corrosion. Cement compositions may also be used in remedial cementing methods to seal cracks or holes in pipe strings or cement sheaths, to seal highly permeable formation zones or fractures, or to place a cement plug and the like.

Pozzolanic materials (e.g., volcanic ash, pumice, opaline, shales, fly ash, etc.) are commonly used in cementing due to favorable pozzolanic properties of these materials. Recently, the industry has shifted towards using various pozzolanic and other pozzolanic alternatives to traditional sources, as using locally-sourced materials may provide certain advantages over globally-sourced materials, for example, lowering of the shipping costs associated with transporting cement over large distances. For example, fly ash may be scarce in some regions where potentially viable alternatives are abundant.

### BRIEF DESCRIPTION OF THE DRAWINGS

These drawings illustrate certain aspects of some of the embodiments of the present disclosure and should not be used to limit or define the disclosure.

FIG. 1 illustrates a schematic of a workflow for retrieving relevant information from a network and predicting performance characteristics of cement, in accordance with some embodiments of the present disclosure.

FIG. 2 illustrates a schematic of a workflow for retrieving relevant information from a network and predicting performance characteristics of cement, in accordance with some embodiments of the present disclosure.

FIG. 3 illustrates a schematic of a cement being introduced into a wellbore.

FIG. 4A is a diagram of an example information handling system which may be utilized to perform various steps, methods, and techniques disclosed herein.

FIG. 4B is a diagram of another example information handling system having a chipset architecture that may be used in executing a method for generating and displaying a graphical user interface (GUI).

FIG. 5 is a flow chart and visual representation of a method for updating a database of pozzolanic materials.

FIG. 6 is a parity plot of measured tensile strength versus modeled tensile strength for training data.

FIG. 7 is a parity plot of measured tensile strength versus modeled tensile strength for testing data.

### DETAILED DESCRIPTION

Disclosed herein are systems and methods for cementing wellbores. Particularly, the present disclosure relates to methods and systems for sourcing pozzolanic materials. More particularly, disclosed herein is a method of retrieving information about pozzolanic material on a publicly available on a network, extracting analytical data from the retrieved information, predicting one or more performance characteristics of the pozzolanic material based at least in part on analytical data extracted from the retrieved information, and mixing the pozzolanic material with Portland or other pozzolanic materials to create a viable cement composition, only if the one or more predicted performance characteristics of the pozzolanic material meet or exceed a minimum performance characteristic.

As alluded to previously, the wellbore cementing industry has seen a recent shift towards using region-specific, or locally sourced, materials, in supply chains. In practice, it may be difficult to actually incorporate these kinds of materials in supply chains for various reasons. For example, while information about these potential candidate materials may be available through accessible databases, including websites and online repositories, it is difficult for even a skilled person to immediately ascertain both economic viability as well as material suitability, as the materials may or not be suited for the extreme conditions of a downhole environment. Specifically, it is both time-consuming and tedious to sift through the morass of information available online and identify useful data. Furthermore, it is difficult to precisely predict how these materials will affect the performance characteristics of cement since the compositions of these locally sourced materials may vary widely from geographic location to geographic location, and even slight changes to a materials' chemistry can disproportionally affect their ability to act as efficient well barriers.

In addition, the process of sourcing these unconventional pozzolanic or other materials may itself be characterized by inefficiency. Information regarding pozzolans is published in many places, including, but not limited to, research publications, vendor published pozzolan reports, public reports from industry groups such as the national pozzolanic association, as well as publicly accessible websites, forums, and encyclopedias, for example. While using a search engine to find pozzolans of interest is possible, search engines may or may not yield the best results, and even when they do provide good results, it still requires a skilled person to manually filter through the morass of information to identify relevant information. This may take time as well as expertise-both commodities which are often in short supply. Further time and expertise are also required when determining viability of a particular candidate material since, as mentioned above, the region-specific materials may have unique compositions which may in some cases unpredictably affect the performance characteristics, e.g., strength, longevity, resistance to carbon dioxide or corrosion, etc., of a final cement.

Improvements associated with some embodiments of the present disclosure may include a heightened efficiency of searching/sourcing region-specific materials, streamlining of the decision-making processes required to assess viability or non-viability of a region-specific material, reduction in the need for time and expertise, reduction in the number of inputs/guidance of an operator, engineer, researcher, or other personnel during planning of cementing jobs, a synchronous ability to simultaneously scavenge publicly information and predict performance characteristics of a material using a single software, reduced risk of remedial cementing operations and/or well abandonment, and a “hands-off,” self-governing, and autonomous approach to organizing a supply chain for cementing that may free up personnel to focus on other tasks, to use non-limiting examples.

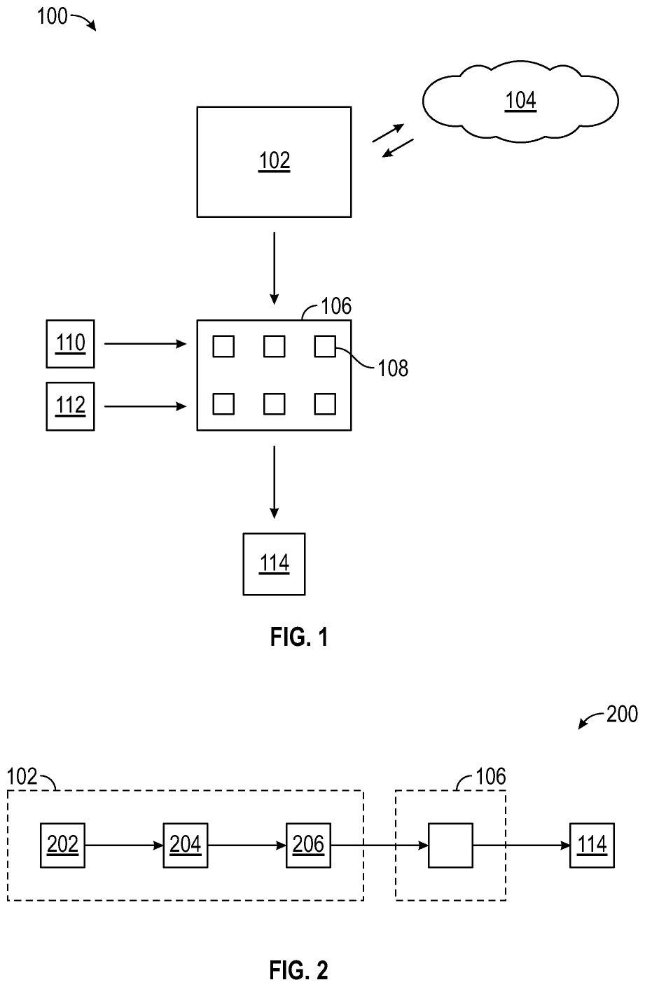

FIG. 1 illustrates a schematic for a workflow 100, in accordance with some examples of the present disclosure. As illustrated, workflow 100 comprises a first module 102, a second module 106, and a third module 114. As used herein, a “module” has an expansive meaning which refers to any of a step or series of steps in a process, an operation, or series of operations in a software, one or more entities configured to perform one or more steps or operations, or a general component, subcomponent, or group of components of a workflow.

As illustrated in FIG. 1, first module 102 performs a variety of tasks, including scavenging the network 104 for unstructured and structured data, schematically shown in FIG. 1 with bi-directional arrows connecting first module 102 to network 104. “Unstructured data,” as used herein, refers to any and all information that is freely available on a network, and which may be formatted in any suitable way whereby it is publicly retrievable. For example, the unstructured data may comprise text strings, images, pdfs, documents, etc., or any suitable computer-readable file, provided that it is retrievable by the first module 102 and publicly available on the network 104. “Structured data,” as used herein, refers to information that is organized, categorized, and formatted in a manner that renders the information searchable within a specific format. Network 104 may comprise any number of interconnected nodes configured to transmit, receive, and/or exchange data, for example, the internet. Means by which the first module 102 may actually retrieve the unstructured data from network 104 are diverse, but may involve, for example, a web crawler, a machine learning model, a scouring algorithm, simple retrieval techniques, combinations thereof, or the like.

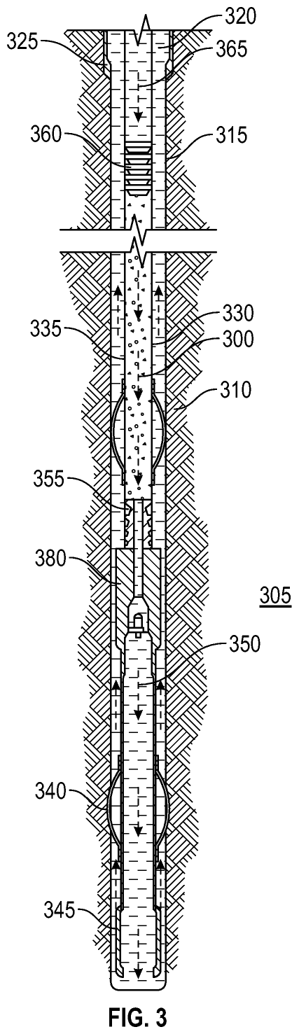

First module 102 may also convert the unstructured data to structured data. Structuring of data may involve or be preceded by, without limitation, standard optical character recognition (OCR), as well as any standard data-cleaning and/or data-simplifying techniques. In operation, first module 102 extracts relevant information from unstructured data, from structured data, or from both structured and unstructured data. “Relevant information” in this context refers generally to any technical information associated with a pozzolanic material which could conceivably be used to predict one or more performance characteristics of that pozzolanic material. Specifically, first module 102 extracts relevant information either directly from the unstructured data retrieved from the network 104, and/or from structured data after the unstructured data has been converted to structured data, for example, via a structuring process, to be discussed in more detail. The specific manner in which operations are performed by the first module 102 may vary to suit a specific application and may conform to one or more of those later described in this disclosure (e.g., referring to FIGS. 2, 3).

Second module 106 performs a variety of tasks, including, using the relevant information output by first module 102 to predict performance characteristics of the material. The second module 106 may accomplish this by, for example, simulating at least one, e.g., a plurality of, cement compositions using the material. Simulating material properties may be performed in various ways, such as with computer-rendering, for example, where a computer program is used to render one, or a plurality of, virtual cement compositions comprising the pozzolanic material(s) and a Portland.

Secondary responsibilities of the second module 106 may include, without limitation, retrieving information from database 110, matching relevant information, e.g., relating to a region-specific composition, similar composition, etc., output by first module 102 to information retrieved from database 110, selecting an appropriate submodule 108, e.g., a model, algorithm, correlation, program, technique, etc., for predicting performance characteristics of a specific type of material, or for predicting a specific type of performance characteristic for a given material. In addition, training of one or more machine learning algorithms may occur within the second module 106. For example, where a submodule 108 comprises a machine learning model for predicting a performance characteristic of a material, second module 106 may have been tasked, at one point or another, with training of one or more machine learning algorithms to form a submodule 108. Training and/or validating may be performed based on training data and/or testing data stored, for example, in module 112. “Training data,” which is used to develop a machine learning model, differs from “testing data,” which may be used to validate a machine learning model. One example of a feature or concept learned by a second module 106 from training data may be, for example, the interchangeability between “Alumina” and “Al₂O₃” when these terms appear within literature scoured from network 104 (e.g., referring to FIG. 1). For example, testing data may be used to assess whether or not a machine learning algorithm has been undertrained or overtrained, or if features learned by a machine learning algorithm are of sufficient number, type, and/or character. In other machine learning examples, however, each submodule 108 is pre-trained, and the second module 106 may not take part in the training of a submodule 108. In yet other examples, one or more of the submodule(s) 108 may comprise non-machine learning models, e.g., deterministic models, to be discussed later.

Database 110 may store information at an on-site or off-site location, for example, at one or more servers. The database 110 may organize data, or be configured to receive organized data, downloaded thereto. This may comprise, or be preceded by, for example, assigning data labels to categorically-recognized types of data. Types of data may include a finite set of classes, or subclasses, each corresponding to a type of analytical property, for example. Types of analytical properties may include, for example, various types of laboratory measurements (e.g., water requirement, rheology, etc.), or other properties, to be discussed later in greater detail.

Where used, module 112 comprises historical information previously stored on at least one database. This may involve, for example, data from previous efforts of characterizing the analytical properties and measuring the performance characteristic of various pozzolanic materials, prior predictions, wellbore logs (e.g., casing logs, bonding logs, etc.), actual material performance data, previously saved, used, or rendered viable cement compositions using different pozzolanic materials, or the like, and may be used to train, validate, inform, test, and/or verify one or more outputs of, submodules of (e.g., predictive machine learning models), and/or inputs of second module 106. In embodiments, the predictive models used herein include trained machine learning models. Specifically, module 112 may comprise an extensive library of historical data, which may be categorized or organized in any suitable manner such that it is retrievable by second module 106 to inform, guide, train, validate, or assist one or more operations of second module 106 or submodule(s) 108 thereof. In one example, module 112 comprises a training dataset comprising data from one or more actual wellbore logs and corresponding cement composition data and/or long-term performance data of a material, which is used to train a specific machine learning algorithm dedicated to predicting performance of similar compositions. “Similar,” as used in this context, is determined primarily on the basis of whether or not a given model predicts the performance of a cement composition with sufficient accuracy that it may be relied on to replace an expert. For example, if a training dataset for a cement composition comprising components A, B, C, and D is used to train a machine learning algorithm to produce a model, and the model is then used to predict performance of a cement composition comprising A, B, and C, or else A, B, C, and D, and the predicted performance is sufficiently accurate to render the need for the expertise unnecessary, then the two compositions are similar. In another example, the data stored in module 112 is used in one or more deterministic equations, for example, a non-linear regression to assist second module 106 with the prediction(s).

Third module 114 performs a variety of tasks, including assessing candidacy of a material. For example, the third module 114 may evaluate, based on an output of second module 106, whether or not the predicted performance characteristics satisfy a predetermined criteria. A predetermined criteria may comprise a minimum, or a maximum, metric, e.g., an analytical property, minimum strength requirement, etc. The metric may be a measurable property of a material if such a material were actually allowed to set, e.g., thickening time, heat of reaction, tensile strength, water requirement, etc. Alternatively, the metric may be more esoteric, such as a unitless, imaginary, or calculated property, e.g., resulting from one or more correlations with measurements of properties of cements using such pozzolanic materials. In one example, a predetermined criteria may comprise one or more minimum acceptable performance characteristics of a wellbore material, which may have been previously defined by an engineer, for example. In an embodiment, a minimum 24-hour UCS of 50 psi (344 kPa), 100 psi (689 kPa), or 500 psi (3447 kPa) may be used as a minimum acceptable performance characteristic. Alternatively, a minimum ultimate tensile strength may be defined as 50 psi (344 kPa), 100 psi (689 kPa), or 500 psi (3447 kPa). In one or more examples, a basis for discriminating between viable and non-viable candidate materials may be derived, at least in part, from features or patterns independently learned by a machine learning model, and which may or may not have a well-understood basis in physics, or which may or may not be mathematically represented beforehand. In essence, the operations performed by third module 114 may result in a determination as to whether or not a particular candidate material is viable or not viable for creating a cement composition for use in a cementing job, or if the composition results in sufficient performance characteristics to perform adequately under wellbore conditions. Wellbore conditions, for example, involving high temperatures and/or high pressures, concentration of carbon dioxide in regions surrounding a wellbore, acidity, etc., may factor into this analysis along with other factors. Output of the third module 114 may comprise, for example, a simple determination as to viability or non-viability of a candidate material. Alternatively, or additionally, output of the third module 114 may comprise a more exhaustive list of diagnostic, evaluative metrics which thoroughly assess the suitability of a material for a cementing job.

As alluded to in the foregoing, the specific manner in which first, second, and third modules 102, 106, and 114 perform their specific functions may vary according to the application. Specifically, in embodiments where each of these modules comprise a different entity or sub-entity of a software, the particular architecture(s) of a particular entity or set of entities may be modified or adapted in a variety of ways to accomplish the specific function of each module. To that end, FIG. 2 provides another schematic illustration of a workflow 200 which may be cumulative, or alternative, to workflow 100 of FIG. 1.

FIG. 2 illustrates a schematic of a workflow 200 for retrieving relevant information from a network and predicting performance characteristics of cement, in accordance with some embodiments of the present disclosure. As with FIG. 1, workflow 100 may comprise a first module 102, a second module 106, and a third module 114.

First module 102 in FIG. 2 comprises submodules 202, 204, and 206. As is consistent with the spirit of this disclosure, it is conceivable that the number and type of submodules of which first module 102 is comprised of may vary to suit the needs of a particular application. In this example, however, first module 102 comprises three submodules 202, 204, 206, the first of which performs tasks, including scavenging unstructured data. Unstructured data may comprise any data or information freely available on a network (e.g., network 104 of FIG. 1). Submodule 202 may comprise, for example, a machine learning model that is trained to discriminate between relevant and irrelevant data during the scavenging, and/or a web-scouring algorithm. For example, web-scouring may be performed by a software entity (e.g., submodule 202, a web-crawler, a network scouring algorithm, retrieval algorithm, etc.) to read, parse through, and/or download the morass of information publicly available on a network (e.g., network 104 of FIG. 1), or else may be performed by more simplistic searching, retrieval, and/or reading algorithms for retrieving information that may later be sorted and/or filtering by a machine learning model of submodule 202. The level of filtering at this stage may vary, ranging from conservative, moderate, or aggressive depending on, for example, a desired program speed, the amount of available computational power (“compute”), or the desired resolution/thoroughness of the search. In one example, a first machine learning model of submodule 202 performs the scavenging, and a second machine learning model of submodule 202 sorts and/or filters the data retrieved by the first machine learning model of submodule 202. Sorting and/or filtering may comprise, for example, assigning one or more labels to the data. Where one or more machine learning models are used, corresponding machine learning algorithms may have been trained with training data such that the model(s) are able to discriminate between the relevant and irrelevant information quickly and effectively. Training data may comprise, for example, labeled data sources, e.g., previously labeled by a skilled person. Types of publicly-available sources of the network 104 that may be identified, retrieved, and/or downloaded by first module 102 may include, for example, published experimental data, published scientific articles, tabulated data, documentation containing analytical and/or performance information relating to one or more pozzolanic materials, online databases, quarterly reviews (e.g., from trade associations), periodic progress reports of funded or unfunded research groups, Health & Environmental Research Online (HERO) records maintained in publicly facing government databases, or the like.

A secondary function of submodule 202 may comprise, in some examples, structuring of the unstructured data. This may comprise, for example, one or more structuring processes, such as an OCR process, as well as recognizing inconsistent column and/or row names which have similar meaning to provide a standardized output, to use a non-limiting example. Structuring of the unstructured data essentially comprises converting the freely available data of a network (e.g., network 104 of FIG. 1) to a form that is readable, storable, and/or configured to occupy less space on a memory device or server, in some examples. Structuring of unstructured data may additionally, or alternatively, comprise recognizing formatting (e.g., rows and/or columns) within a data source and recreating one or more structures (e.g., tables) preserving the formatting. In one or more examples, submodule 202 may be characterized as an “artificially intelligent framework,” whereby one or more trained machine learning models are configured to identify and/or extract data from documents ingested within the framework. Such a framework may involve, in some examples, a large language model (LLM). In one or more examples, submodule 202 may continuously, or semi-continuously, pass information to submodule 202. “Continuously” in this context means that information is passed from one software entity to another at least one time per hour, every hour, for a period of at least 7 consecutive days. For example, continuously passing of information may comprise ingesting a document into the framework at least 5 times per hour, at least 10 times per hour, at least 15 times per hour, at least 100 times per hour, at least 1000 times per hour, and any ranges therebetween, every hour for a sustained period of at least 7 consecutive days. “Semi-continuously” in this context means that information is not “continuous,” but is passed from one software entity to another on a basis that appears to be regular. For example, semi-continuous passing of information may comprise ingesting a document into the framework at least 5 times per month, every month, for at least 5 consecutive months.

The structured data output by submodule 202 is then passed to submodule 204. Submodule 204 is primarily tasked with extracting analytical and/or performance information from the structured data. This may comprise identifying and then isolating specific types of information present within the structured data, and may be achieved by passing, for example, the structured data through a highly discriminatory parsing function which thoroughly scrutinizes the structured data. The extraction may be performed in a variety of ways, ranging from more rudimentary and simple techniques to more complex methods. For example, the extracting of analytical information may be performed by a machine learning model of submodule 204. Such a model may be different from, or the same as, any of the machine learning models previously described. “Analytical information” in this context refers to physical, measurable properties of one or more given pozzolanic materials which could conceivably be used to predict a performance characteristic or performance characteristic of a cement involving the given pozzolanic material(s). “Performance characteristic” refers to a measurable property of a cement or slurry that involves one or more given pozzolanic materials, and which may refer in some examples to a measurable characteristic of a slurry during setting of the cement, e.g., thickening time, heat of reaction, strength, longevity, resistance to carbon dioxide or corrosion etc., or to a measurable final property of the set cement, e.g., tensile strength, young's modulus, etc. As with submodule 202, submodule 204 may be configured to continuously, or semi-continuously, pass information to the next submodule, i.e., submodule 206.

The trained machine learning models in the submodules of FIG. 2 may be underpinned by machine learning algorithms, which may be capable of capturing the underlying relationships within a dataset, may be broken into different categories. One such category may comprise whether the machine learning algorithm functions using supervised, unsupervised, semi-supervised, or reinforcement learning. The objective of a supervised learning algorithm may be to determine one or more dependent variables based on their relationship to one or more independent variables. Supervised learning algorithms are named as such because the dataset comprises both independent and corresponding dependent values where the dependent value may be thought of as “the answer,” that the model is seeking to predict from the underlying relationships in the dataset. As such, the objective of a model developed from a supervised learning algorithm may be to predict the outcome of one or more scenarios which do not yet have a known outcome. Supervised learning algorithms may be further divided according to their function as classification and regression algorithms. When the dependent variable is a label or a categorical value, the algorithm may be referred to as a classification algorithm. When the dependent variable is a continuous numerical value, the algorithm may be a regression algorithm. In a non-limiting example, algorithms utilized for supervised learning may comprise Neural Networks, K-Nearest Neighbors, Naïve Bayes, Decision Trees, Classification Trees, Regression Trees, Random Forests, Linear Regression, Support Vector Machines (SVM), Gradient Boosting Regression, Genetic Algorithm, and Perception Back-Propagation. The objective of unsupervised machine learning may be to identify similarities and/or differences between the data points within the dataset which may allow the dataset to be divided into groups or clusters without the benefit of knowing which group or cluster the data may belong to. Datasets utilized in unsupervised learning may not comprise a dependent variable as the intended function of this type of algorithm is to identify one or more groupings or clusters within a dataset. In a non-limiting example, algorithms which may be utilized for unsupervised machine learning may comprise K-means clustering, K-means classification, Fuzzy C-Means, Gaussian Mixture, Hidden Markov Model, Neural Networks, and Hierarchical algorithms. The process of training the neural network may entail determining the suitable weights that produce a model capable of being utilized as a submodule discussed herein. The datasets used to train the models herein may include performance characteristic of various pozzolanic materials, prior predictions, wellbore logs (e.g., casing logs, bonding logs, etc.), actual material performance data, previously saved, used, or rendered viable cement compositions using different pozzolanic materials, or the like. Furthermore, building the machine learning model may be an iterative process which comprises a validation component and/or reinforcement learning, as previously mentioned. Once a model which meets one or more criterion for deployment, which in a non-limiting example may comprise achieving a certain level of accuracy, it may be incorporated into submodule. In some examples, the level of accuracy which meets the deployment criterion may range from about 50% to about 100%. Alternatively, the level of accuracy may range from about 50% to about 60%, about 60% to about 70%, about 70% to about 80%, about 80% to about 90%, or about 90% to about 100%.

In some examples, the deep learning algorithms may include convolutional neural networks, long short term memory networks, recurrent neural networks, generative adversarial networks, attention neural networks, zero-shot models, fine-tuned models, domain-specific models, multi-modal models, transformer architectures, radial basis function networks, multilayer perceptrons, self-organizing maps, deep belief networks, and combinations thereof.

Non-limiting examples of analytical properties which may be extracted by submodule 204 include specific surface area, water requirement, water retention, oxide content, x-ray diffraction (XRD), crystalline silica content, amorphous silica content, morphology, rheology data, spectroscopy data, microscopy data, x-ray fluorescence data, particle size, particle size distribution, specific heat, heat of reaction, thermal conductivity, heat content, scanning electron microscopy data, energy-dispersive X-ray spectroscopy data, infrared spectroscopy data, surface area (e.g., specific surface area), specific gravity, radius of gyration, thermogravimetric data, mass spectroscopy data, secondary ion mass spectroscopy data, electron energy mass spectrometry data, dispersive x-ray spectroscopy data, auger electron spectroscopy, inductively coupled plasma mass spectroscopy (ICP-MS) data, thermal ionization mass spectroscopy data, glow discharge mass spectroscopy data, x-ray photoelectron spectroscopy data, adsorption (e.g., Brunauer-Emmett-Teller analysis), lime content, calcium hydroxide content, silica oxide content, calcium oxide content, aluminum oxide content, sodium oxide content, iron oxide content, sulfur content, iron content, calcium content, sodium content, potassium content, magnesium content, alkali content, mixability (e.g., as determined by API RP 10B published on Dec. 1, 1997), stability, bulk density, sphericity, dispersing ability, fluid loss control ability, density, reactivity, methylene blue staining, ethylene glycol monoethyl ether adsorption, protein-retention, combinations thereof, and the like. An analytical property may comprise, or be derived from one or more API tests, as set forth in the API recommended practice for testing well cements (published as ANSI/API recommended practice 10B-2), in some examples. An analytical property may comprise, in some examples, results from one or more laboratory experiments.

It should be understood that some of the analytical properties listed above may have specific meanings within the context of wellbore cements. For example, water requirement is typically defined as the amount of mixed water that is required to be added to a powdered, solid particulate material to form a mixable slurry during the wellbore cementing job. Water requirement for a particular cement component may be determined by a process that includes a) preparing a Waring blender with a specified amount of water, b) agitating the water at a specified blender rpm, c) adding the powdered solid that is being investigated to the water until a specified consistency is obtained, and d) calculating the water requirement based on the ratio of water to solids required to reach the desired consistency. The workflows 100, 200 may identify these specific analytical properties (e.g., with first module 102 or 106), as well as other analytical properties.

Non-limiting examples of performance characteristics which may be extracted by submodule 204 include compressive strength, e.g., unconfined ultimate compressive strength (UCS), tensile strength (TS), young's modulus of elasticity (YM), thickening time (TT), heat of hydration, extent of reaction, reactivity, density, Poisson's Ratio, combinations thereof, and the like. Alternatively, the metric may be more esoteric, such as a unitless, imaginary, or calculated property, e.g., resulting from one or more correlations with measurements of properties of cements using such pozzolanic materials. In some examples, however, first module 102 does not extract performance characteristics from the data sources of network 104, but extracts only analytical properties, e.g., associated with one or more pozzolanic materials.

Without limiting to a specific testing technique, compressive strength is generally the capacity of a solid particulate material or structure to withstand shear forces. The compressive strength of the cement component may be measured at a specified time after a cement component has been mixed with water and the resultant cement slurry is maintained under specified temperature and pressure conditions. For example, compressive strength can be measured at a time in the range of about 24 to about 48 hours (or longer) after a fluid is mixed and the fluid is maintained at a temperature of from 100° F. to about 200° F. and atmospheric pressure. Measuring compressive strength are not limited to these ranges, and also may also be performed at higher temperatures in some examples, for example, at temperatures exceeding 300° F. Compressive strength can be measured by either a destructive method or non-destructive method. The destructive method physically tests the strength of treatment fluid samples at various points in time by crushing the samples in a compression-testing machine. The compressive strength may be calculated from the failure force divided by the cross-sectional area on which such a force is applied and is reported in units of pound-force per square inch (psi). Non-destructive methods typically may employ an Ultrasonic Cement Analyzer (“UCA”), available from Fann® Instrument Company, Houston, TX. Compressive strengths may be determined in accordance with API RP 10B-2, Recommended Practice for Testing Well Cements, First Edition, July 2005.

Without being limited to any specific testing technique, tensile strength is generally the capacity of a solid particulate material to withstand loads tending to elongate, as opposed to compressive strength. For example, the tensile strength of a cement component may be measured at a specified time after a cement component has been mixed with water and the resultant cement slurry is maintained under specified temperature and pressure conditions. For example, tensile strength can be measured at a time in the range of about 24 to about 48 hours (or longer) after a sample is mixed and the sample is maintained at a temperature of from 100° F. to about 200° F. and atmospheric pressure. Measuring tensile strength are not limited to these ranges, and also may also be performed at higher temperatures in some examples, for example, at temperatures exceeding 300° F. Tensile strength may be measured using any suitable method, including without limitation in accordance with the procedure described in ASTM C307. That is, specimens may be prepared in briquette molds having the appearance of dog biscuits with a one square inch cross-sectional area at the middle. Tension may then be applied at the enlarged ends of the specimens until the specimens break at the center area. The tension in pounds per square inch at which the specimen breaks is the tensile strength of the solid particulate material tested.

Young's modulus also referred to as the modulus of elasticity is a measure of the relationship of an applied stress to the resultant strain. In general, a highly deformable (plastic) solid particulate material will exhibit a lower modulus for the same stress compared to a less deformable (steel) material. Thus, the Young's modulus is an elastic constant that demonstrates the ability of the tested solid particulate material to deform elastically under applied loads. A number of different laboratory techniques may be used to measure Young's modulus of a sample comprising a pozzolanic component after a test sample has been allowed to set for a period of time at specified temperature and pressure conditions.

Although only some select laboratory techniques may have been mentioned, it should be understood that there may be many analytical techniques that may be appropriate or not appropriate for a certain sample. One of ordinary skill in the art with the benefit of this disclosure would be able to select an appropriate analytical technique to determine a certain property of interest.

The extracted analytical information and/or performance data is passed to submodule 206 in some examples, where it may be stored for later retrieval by second module 106. Further, the submodule 204 may be configured in one or more examples to identify discrepancies or conflicting information and, depending on the seriousness of the conflicts, include or exclude the information before passing the information to submodule 206.

Submodule 206 comprises a database for storing information after one or more of the operations, e.g., retrieving, structuring, filtering, extracting, etc., of previous submodules 202, 204. As mentioned, submodule 206 may be updated continuously, or semi-continuously, depending on the activity of the previous submodules 202, 204. As such, submodule 206 may comprise, or be configured to comprise, information that is perpetually up-to-date. In some examples, this represents one technological advantage of the present disclosure as the information supplied to second module 106 by submodule 206 may be constantly informed by, derived from, or accounting for any new information appearing within a network (e.g., network 104 of FIG. 1). The type of information stored within submodule 206 may comprise, for example, analytical data, performance data, or both, and which may comprise historical data recorded from previous cementing jobs or other wellbore operations, e.g., from wellbore logs, measurements of downhole measurement tools, etc.

Second module 106 may comprise one or more models. Model(s) of second module 106 may be built using deterministic equations (e.g., physics-based, non-linear regression, etc.), or alternatively, “black-box” models, for example, Random Forest, XG-Boost, Neural Networks, etc. Model(s) of second module 106 may be empirical, semi-empirical, or neither. Second module 106 may be primarily tasked with predicting the performance, e.g., a performance characteristic or performance characteristic, of one or more candidate cement compositions that includes one or more given pozzolanic materials.

Candidate cement compositions to be evaluated in second module 106 may be input manually (e.g., by a user via a computer) or may be autonomously generated by second module 106. As mentioned, a candidate cement composition may comprise one or more pozzolanic materials, which may be region-specific and/or sourced locally. Predicting performance of candidate cement compositions may be achieved by separately rendering a virtual cement composition for each candidate, or else by generating predictive results for a hypothetical combinations of various candidate materials. For example, second module 106 may predict the unconfined ultimate compressive strength (UCS) and tensile strength of a hypothetical cement resulting from preparing a slurry comprising a first locally-sourced pozzolanic material, a second locally-sourced pozzolanic material, a non-pozzolanic material, and water. In another example, second module 106 predicts one or more performance characteristics of a candidate cement composition by adding lime, i.e., calcium hydroxide, and/or water, to the one or more pozzolanic materials. As many of the pozzolanic materials may be silica- and alumina-rich, but may otherwise have low levels of lime, it may be necessary to augment a prediction by adding lime to the candidate composition to improve accuracy of the prediction. This may involve, for example, creating, or modifying the concentration of, a virtual cement composition such that that an amount of a material containing lime (e.g., Portland cement) is present in a suitable amount that would allow for hydration were a slurry prepared in accordance with the virtual cement and allowed to set in actuality. Proportions of the various components of the candidate cement composition, i.e., “hypothetical slurry,” may be varied, with predictions being made for a permutation of the various concentrations until, for example, the predicted performance meets a predetermined threshold.

Where candidate cement compositions are generated autonomously, second module 106 may generate one or more seed candidates, e.g., “initial guesses,” to predict the performance of the various combinations of the pozzolanic and/or other materials to be evaluated in third module 114. Generation of these seed candidates may be done randomly, or formulaically, e.g., conforming to a pre-specified schedule, with the concentrations of the various species being tuned across multiple iterations in some examples, until third module 114 “converges” to an acceptable candidate composition, for example. Alternatively, generating of candidate cement compositions may be informed by an external input, as mentioned above, such as in a scenario where personnel recommend a seed candidate, or else sets a limit or other boundary condition as to a specified amount, or concentration, of a final cement product. In either case, second module 106 may retrieve information from submodule 206 to inform the prediction of the one or more performance characteristics. Thus, retrieval of information from submodule 206 may be informed by one or more external inputs or by autonomously generated seed candidates. Retrieval of information from submodule 206 may be performed in any suitable manner, for example, after searching through one or more data labels attached to the various types of data stored within a database of submodule 206 and matching the appropriate data label to the candidate cement composition.

As with FIG. 1, third module 114 is primarily tasked with assessing viability of a one or more candidate materials based on output of second module 106. As described above, output of second module 106 comprises prediction(s). The prediction(s) ultimately determine, or may be used to determine, whether or not a candidate composition is viable or non-viable. Operations performed by or to one or more of submodule 206, second module 106, and/or third module 114 may be repeated iteratively in some examples until a cement composition achieves one or more satisfactory predicted performance characteristics and/or cost, desired quantity, total logistical expenditure of a supply chain or cementing job, etc.

Referring now to FIGS. 1 and 2, following assessment in third module 114, a supply chain may be modified in some examples to include one or more candidate materials, modify an amount of one or more candidate materials or pre-existing materials of the supply chain, and/or to remove one or more pre-existing materials entirely. “Pre-existing” in this context refers to a material that is currently being used/purchased in a supply chain to supply one or more cementing operations in a region. This may be performed manually by an engineer, for example, or may be performed by third module 114. Alternatively, workflow 100 and/or workflow 200 may be adapted to include another module (not shown) which receives as input the output from one or both of modules 106, 114, and automatically makes changes to the supply chain. Updating the supply chain may involve actually effectuating purchases for one or more materials, or may simply comprise outputting, e.g., displaying, a recommendation, such as a supply chain plan which reflects the recommended change. In some examples, updating a supply chain or a supply chain plan may be an iterative process which is iteratively repeated until a condition is met, for example, a maximum or a target cost, estimated shipping time to meet a deadline, total shipping distance, etc.

Reference is now made to FIG. 3, illustrating use of a cement composition 300. Cement composition 300 may comprise any of the components described herein. Cement composition 300 may comprise one or more locally-sourced or region-specific pozzolanic materials identified and evaluated with the methods and systems disclosed herein. Turning now to FIG. 3, the cement composition 300 may be placed into a subterrancan formation 303 in accordance with example systems, methods, and cement compositions. As illustrated, a wellbore 310 may be drilled into the subterrancan formation 303. While wellbore 310 is shown extending generally vertically into the subterranean formation 303, the principles described herein are also applicable to wellbores that extend at an angle through the subterranean formation 303, such as horizontal and slanted wellbores. As illustrated, the wellbore 310 comprises walls 313. In the illustration, a surface casing 325 has been inserted into the wellbore 310. The surface casing 325 may be cemented to the walls 313 of the wellbore 310 by cement sheath 323. In the illustration, one or more additional conduits (e.g., intermediate casing, production casing, liners, etc.), shown here as casing 330 may also be disposed in the wellbore 310. As illustrated, there is a wellbore annulus 333 formed between the casing 330 and the walls 313 of the wellbore 310 and/or the surface casing 325. One or more centralizers 340 may be attached to the casing 330, for example, to centralize the casing 330 in the wellbore 310 prior to and during the cementing operation.

With continued reference to FIG. 3, the cement composition 300 may be pumped down the interior of the casing 330. The cement composition 300 may be allowed to flow down the interior of the casing 330 through the casing shoe 343 at the bottom of the casing 330 and up around the casing 330 into the wellbore annulus 333. The cement composition 300 may be allowed to set in the wellbore annulus 333, for example, to form a cement sheath that supports and positions the casing 330 in the wellbore 310. While not illustrated, other techniques may also be utilized for introduction of the cement composition 300. By way of example, reverse circulation techniques may be used that include introducing the cement composition 300 into the subterranean formation 303 by way of the wellbore annulus 333 instead of through the casing 330. As it is introduced, the cement composition 300 may displace other fluids 320, such as drilling fluids and/or spacer fluids that may be present in the interior of the casing 330 and/or the wellbore annulus 333. While not illustrated, at least a portion of the displaced fluids 320 may exit the wellbore annulus 333 via a flow line and be deposited, for example, in one or more retention pits. A bottom plug 355 may be introduced into the wellbore 310 ahead of the cement composition 300, for example, to separate the cement composition 300 from the fluids 320 that may be inside the casing 330 prior to cementing. After the bottom plug 355 reaches the landing collar 380, a diaphragm or other suitable device should rupture to allow the cement composition 300 through the bottom plug 355. The bottom plug 333 is shown on the landing collar 380. In the illustration, a top plug 360 may be introduced into the wellbore 310 behind the cement composition 300. The top plug 360 may separate the cement composition 300 from a displacement fluid 363 and also push the cement composition 300 through the bottom plug 333.

As mentioned, non-traditional and/or locally-sourced or region-specific pozzolanic materials may be identified and incorporated into a supply chain in accordance with the present disclosure. Thus, cement composition 300 may comprise one or more of these materials. Such materials may comprise one or more pozzolans. A variety of different pozzolans may be suitable for use in embodiments. Example embodiments comprising a pozzolan may comprise, without limitation, fly ash, silica fume, Silicalite, metakaolin, zeolites, a natural pozzolan, byproducts of industrial processes, slag from cement kilns, spent waste, or combinations thereof. In some embodiments, the pozzolanic components present in the cement composition may consist essentially of one or more pozzolans, which may be ground or unground. For example, the pozzolanic components of cement composition 300 may primarily comprise the pozzolan without any additional pozzolanic components (e.g., Portland cement) that hydraulically set in the presence of water.

Additionally, or alternatively, cement composition 300 may comprise, for example, one or more hydraulic cements. A variety of hydraulic cements may be utilized in accordance with the present invention, including, but not limited to, those comprising calcium, aluminum, silicon, oxygen, iron, and/or sulfur, which set and harden by reaction with water. Suitable hydraulic cements include, but are not limited to, Portland cements, pozzolana cements, gypsum cements, high alumina content cements, silica cements, and any combination thereof. In certain embodiments, a hydraulic cement may comprise a Portland cement. In some embodiments, the Portland cements that are suited for use in the present invention are classified as Classes A, C, H, and G cements according to American Petroleum Institute, API Specification for Materials and Testing for Well Cements, API Specification 10, Fifth Ed., Jul. 1, 1990. In addition, in some embodiments, cements suitable for use in the present invention may include cements classified as ASTM Type I, II, or III. Alternatively, one or more hydraulic cements may be unclassified, for example, by virtue of being locally sourced, recently appearing within a network 104, recently being added to database 110 (e.g., referring to FIG. 1), or the like.

Additionally, or alternatively, cement composition 300 may comprise, for example one or more other materials. One or more of these other materials may comprise, may be included in, or may later be combined with, one or more of the locally-sourced materials identified in a workflow 100 or 200 of FIG. 1 or 2, in some examples, to form a cement composition 300. Non-limiting examples of these other materials may comprise resin(s), one or more cement additives, geopolymer cement, calcined clays, metal silicate sources, silica sources, alumina, slag, silica fume, calcium aluminate hydrate, cement kiln dust, silica flour, natural glass, diatomaceous earth, metakaolin, zeolite, shale, agricultural waste ash (e.g., rice husk ash, sugar cane ash, and bagasse ash), crystalline silica, zeolite, Portland cement, hydrated lime, a calcium source, weighting agents, retarders, accelerators, activators, gas control additives, lightweight additives, gas-generating additives, mechanical-property-enhancing additives, defoaming agents, dispersants, thixotropic additives, suspending agents, rheology modifiers, and any combinations thereof.

The disclosed systems, and methods may directly or indirectly affect any pumping systems, which representatively includes any conduits, pipelines, trucks, tubulars, mud pits, storage facilities or units, composition separators, heat exchangers, sensors, gauges, and/or pipes which may be coupled to the pump and/or any pumping systems and may be used to fluidically convey the cement compositions downhole, any pumps, compressors, or motors (e.g., topside or downhole) used to drive the cement composition 300 into motion, any valves or related joints used to regulate the pressure or flow rate of the cement compositions, and any sensors (i.e., pressure, temperature, flow rate, etc.), gauges, and/or combinations thereof, and the like. Cement composition 300 may also directly or indirectly affect any mixing hoppers and retention pits and their assorted variations. Cement composition 300 may also directly or indirectly affect various downhole equipment and tools that may come into contact with cement composition 300 such as, but not limited to, wellbore casing, wellbore liner, completion string, insert strings, drill string, coiled tubing, slickline, wireline, drill pipe, drill collars, mud motors, downhole motors and/or pumps, cement pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices, (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like.

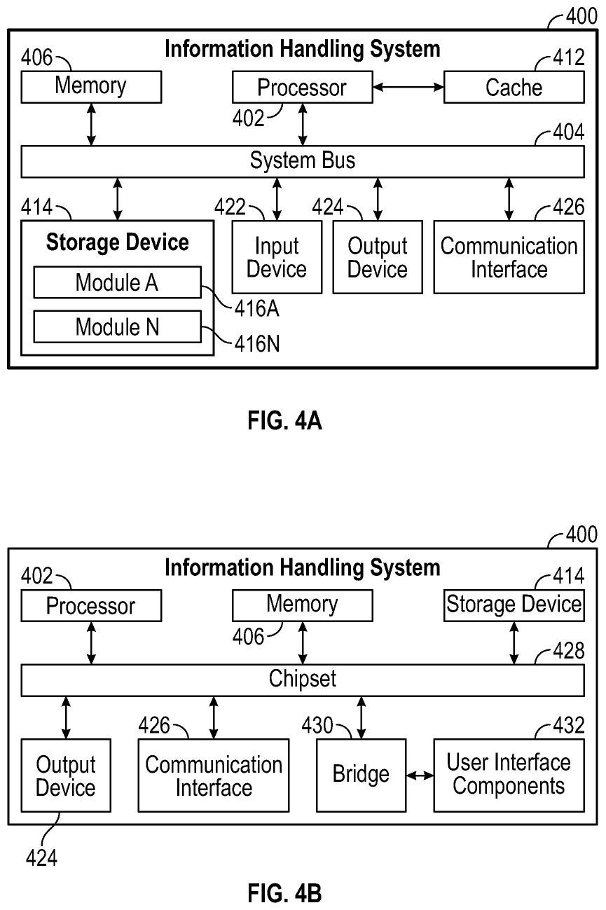

FIG. 4A is a diagram of an example information handling system which may be utilized to perform various steps, methods, and techniques disclosed herein. As illustrated, information handling system 400 includes processor 402 and system bus 404 that operatively connects processor 402 to one or more other component(s) of information handling system 400. Other components of information handling system 400 may include (i) memory 406, (ii) storage device 414, (iii) input device 422, (iv) output device 424, and (v) communication interface 426. These other components may control or be configured to control processor 402 to perform various operations or actions. Each component described is depicted and disclosed as individual functional components. However, these individual components may be combined (or divided) into fewer (or more) components in any possible combination or configuration.

Non-limiting examples of information handling system 400 include a general purpose computer (e.g., a personal computer, desktop, laptop, tablet, smart phone, etc.), a network device (e.g., switch, router, multi-layer switch, etc.), a server (e.g., a blade-server in a blade-server chassis, a rack server in a rack, etc.), a controller (e.g., a programmable logic controller (PLC)), and/or any other type of information handling system 400 with the aforementioned capabilities. Further, information handling system 400 may be operatively connected to another information handling system 400 via a network in a distributed computing environment. As used herein, a “computing device” may be equivalent to an information handling system.

Processor 402 may be an integrated circuit configured to process computer-executable instructions (e.g., code, algorithms, software) and may take the form of any general-purpose processor (e.g., a central processing unit (CPU)). Processor 402 may execute (e.g., read and process) computer-executable instructions stored on storage device 414, memory 406, and/or cache 412. Processor 402 may be a self-contained computing system, containing multiple cores or processors, a bus, memory controller, cache, etc. Processor 402 may include multiple processors, such as a system having multiple, physically separate processors in different sockets, or a system having multiple processor cores on a single physical chip. A multi-core processor may be symmetric or asymmetric. Further, processor 402 may include multiple distributed processors located in multiple separate computing devices but configured to operate together via a communications network. Multiple processors or processor cores may share resources such as memory 406 or cache 412 or may operate using independent resources.

Non-limiting examples of processor 402 include one or more state machines, an application specific integrated circuit (ASIC), a programmable gate array (PGA), a field PGA (FPGA), a digital signal processor (DSP), or any other digital or analog circuitry configured to interpret, execute program instructions, process data, or any combination thereof. Processor 402 may logically include a hardware or software module (e.g., software module A 216A and/or software module N 416N stored in storage device 414), which may be configured to control processor 402 as well as a special-purpose processor where software instructions are incorporated into processor 402.

Processor 402 may be designed for and/or include additional capabilities designed for use with machine learning, deep learning, and/or artificial intelligence applications. Accordingly, additional non-limiting examples of processor 402 include a graphics processing unit (GPU), a GPU with a compute unified device architecture (CUDA), a data processing unit (DPU), a tensor processing unit (TPU), a tensor streaming processor (TSP), a neural engine, and a processor with an embedded/integrated neural engine core(s).

Processor 402 may execute one or more instruction(s) for processing one or more measurement(s) according to any one or more algorithm(s), function(s), or calculation(s) discussed below. It may be appreciated that the disclosure may operate on information handling system 400 with more than one processor 402 or on a group of information handling systems 400 networked together to provide greater processing capability. The logical operations performed by processor 402 may implemented as (i) a sequence of computer implemented steps, operations, or procedures running on a programmable circuit within a general use computer, (ii) a sequence of computer implemented steps, operations, or procedures running on a specific-use programmable circuit, and/or (iii) interconnected machine modules or program engines within the programmable circuits.

Information handling system 400 may execute some, or all, of the recited methods, may be a part of the recited systems, and/or may operate according to instructions in the recited tangible computer-readable storage devices. Such logical operations may be implemented as modules configured to control processor 402 to perform particular functions according to the programming of software modules 216A and 416N.

Cache 412 may be one or more hardware device(s) capable of storing digital information (e.g., data) in a non-transitory medium. Cache 412 may be considered “high-speed”, having comparatively faster read/write access than memory 406 and storage device 414, and therefore utilized by processor 402 to process data more quickly than data stored in memory 406 or storage device 414. Accordingly, information handling system 400, via processor 402, may copy data from memory 406 and/or storage device 414 to cache 412 for comparatively speedier access and processing. Processor 402 may be operatively connected to (or include) cache 412. Cache 412 expressly excludes media such as transitory waves, energy, carrier signals, electromagnetic waves, and signals per se.

Memory 406 may be one or more hardware device(s) capable of storing digital information (e.g., data) in a non-transitory medium. In any embodiment, when accessing memory 406, software may be capable of reading and writing data at the smallest units of data normally accessible (e.g., “bytes”). Specifically, memory 406 may include a unique physical address for each byte stored thereon, thereby enabling software to access and manipulate data stored in memory 406 by directing commands to specific physical addresses that are associated with a byte of data (i.e., “random access”). Non-limiting examples of memory 406 devices include flash memory, random access memory (RAM), dynamic RAM (DRAM), static RAM (SRAM), resistive RAM (ReRAM), read-only memory (ROM), and electrically erasable programmable ROM (EEPROM). In any embodiment, memory 406 devices may be volatile or non-volatile. Memory 406 expressly excludes media such as transitory waves, energy, carrier signals, electromagnetic waves, and signals per sc.

Storage device 414 may be one or more hardware device(s) capable of storing digital information (e.g., data) in a non-transitory medium. Non-limiting examples of storage device 414 include (i) integrated circuit storage devices (e.g., a solid-state drive (SSD), Non-Volatile Memory Express (NVMe), flash memory, etc.), (ii) magnetic storage devices (e.g., a hard disk drive (HDD), floppy disk, tape, diskette, cassettes, etc.), (iii) optical media (e.g., a compact disc (CD), digital versatile disc (DVD), etc.), and (iv) printed media (e.g., barcode, quick response (QR) code, punch card, etc.). In any embodiment, prior to reading and/or manipulating data located in storage device 414, data may first be copied in “blocks” (instead of “bytes”) to other, intermediary storage mediums (e.g., memory 406, cache 412) where the data can then be accessed in “bytes”. Storage device 414 expressly excludes media such as transitory waves, energy, carrier signals, electromagnetic waves, and signals per se.

As used herein, a non-transitory computer readable medium means any (i) storage device 414, (ii) memory 406, (iii) cache 412, and/or (iv) any other hardware device capable of non-transitorily storing and/or carrying data. When data that includes computer-executable instructions are provided to information handling system 400 via communication interface 426, information handling system 400 writes that data to memory 406, storage device 414, or cache 412. Thus, the data received via communication interface 426 may be stored in a non-transitory computer-readable medium. Combinations of the above should also be included within the scope of the computer-readable media.

A software module (e.g., module A 216A, module N 416N) may be data that includes computer-executable instructions (e.g., code, algorithms, software, program). Computer-executable instructions include, for example, instructions and data which cause information handling system 400, and/or processor 402 thereof, to perform a certain function or series of functions. Computer-executable instructions also include program modules that are executed in standalone or network environments. Generally, program modules include routines, programs, components, data structures, objects, and the functions inherent in the design of special-purpose processors. These program modules may be utilized to perform particular tasks or implement particular abstract data types. Computer-executable instructions, associated data structures, and program modules represent examples of code for executing steps of the methods disclosed herein.

Input device 422 may be one or more hardware device(s) that generate and/or input data into information handling system 400 via one or more sensor(s) or reading device(s). Non-limiting examples of input device 422 include a mouse, a keyboard, a monitor, a camera, a microphone, touchpad, touchscreen, fingerprint reader, joystick, gamepad, and/or drive for reading non-transitory computer readable media (e.g., a compact disc (CD) drive, a floppy disk drive, tape drive, etc.). To enable user interaction with information handling system 400, input device 422 represents any number of input mechanisms, such as a microphone for speech, a touch-sensitive screen for gesture or graphical input, and so forth.

Output device 424 may be one or more hardware device(s) that export data from information handling system 400 via peripheral device(s). Non-limiting examples of an output device 424 include a visual display monitor, speakers, printer, LED bulb (e.g., a status light), haptic feedback device, and/or drive for writing to non-transitory computer readable media (e.g., a CD drive, a floppy disk drive, tape drive, etc.).

Communication interface 426 may be one or more hardware device(s) that provide the capability to send and/or receive data with one or more other information handling systems 400 via a network. Communication interface 426 may communicate via any suitable form of wired interface (e.g., Ethernet, fiber optic, serial communication etc.) and/or wireless interface (e.g., Wi-Fi® (Institute of Electrical and Electronics Engineers (IEEE) 802.11), Bluetooth® (IEEE 802.15.1), etc.) and utilize one or more protocol(s) for the transmission and receipt of data (e.g., transmission control protocol (TCP), internet protocol (IP), remote direct memory access (RDMA), etc.). Non-limiting examples of communication interface 426 include a network interface card (NIC), a modem, an Ethernet card/adapter, and a Wi-Fi® card/adapter.

System bus 404 may be a system of hardware connections (e.g., sockets, ports, wiring, conductive tracings on a printed circuit board (PCB), etc.) used for sending (and receiving) data to (and from) each of the devices connected thereto. System bus 404 allows for communication via an interface and protocol (e.g., inter-integrated circuit (I2C), peripheral component interconnect (express) (PCI (c)) fabric, etc.) that may be commonly recognized by the devices utilizing system bus 404. System bus 404 may be any of several types of bus structures including a memory bus or memory controller, a peripheral bus, and a local bus using any of a variety of bus architectures. As a non-limiting example, a basic input/output (BIOS) stored in ROM, may provide the basic routine that helps to transfer information between elements using system bus 404, within information handling system 400 (e.g., during initialization). Each of the previously discussed components of information handling system 400 may be operatively connected to system bus 404, in turn allowing each of those components to communicate through system bus 404.

FIG. 4B is a diagram of another example information handling system having a chipset architecture that may be used in executing a method for generating and displaying a graphical user interface (GUI). Information handling system 400 is an example of computer hardware, software, and firmware that may be used to implement the disclosed technology. Information handling system 400 may include a processor 402, representative of any number of physically and/or logically distinct resources capable of executing software, firmware, and hardware configured to perform identified computations.

Chipset 428 may be one or more hardware device(s) that controls the flow of data to and from processor 402. As a non-limiting example, chipset 428 may obtain data from processor 402 (and/or cache 412 thereof) and output that data to output device 424 (e.g., a visual display monitor). Further, chipset 428 may interface with one or more communication interface(s) 426, with differing physical interfaces, to enable communication with those interfaces. As another non-limiting example, chipset 428 may receive raw data via communication interface 426, write the raw data to memory 406, send that data to processor 402 for processing, retrieve the processed data from processor 402, and then write the processed data to memory 406 and/or storage device 414.

Bridge 430 may be one or more hardware device(s) that act as an interface between chipset 428 and one or more user interface component(s) 432. Non-limiting examples of user interface components 432 may include any input device 422 or output device 424 described in FIG. 4A. In general, inputs to information handling system 400 may come from any of a variety of sources—machine and/or human generated.

Some applications of the methods for generating, displaying, and using the GUI disclosed herein may include receiving ordered datasets over the physical interface. Such ordered datasets may be generated by information handling system 400 itself (e.g., by processor 402 analyzing data stored in memory 406 or storage device 414). Further, information handling system 400 may receive inputs from a user via user interface components 432 and executes corresponding functions, such as browsing functions by interpreting these inputs using processor 402.

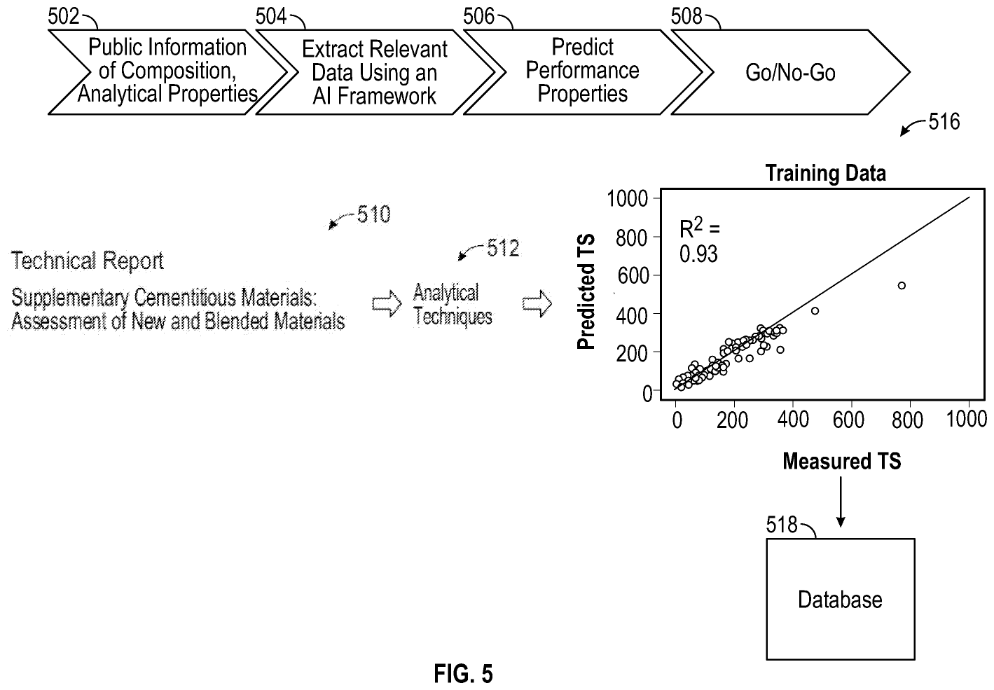

FIG. 5 is a flow chart and visual representation of a method 500 for updating a database of pozzolanic materials. Method 500 begins with step 502 where public information about pozzolanic materials is provided to a trained AI framework. The public information may include composition and analytical properties of pozzolanic materials which is analyzed by the trained AI framework as described herein. An example of public information includes technical reports from industry such as technical report 510. As shown in FIG. 5, technical report 510 contains a table of pozzolan data as well as other physical and chemical properties of pozzolans. Method 500 proceeds to step 504 where relevant data for one or more pozzolans is extracted from the pozzolan data including relevant data 512 containing analytical data for the one or more pozzolans. Method 500 proceeds to step 506 where the performance properties for each one the one or more pozzolans is predicted, using the relevant data 512 from step 504, in a submodule such as submodule 108 in FIG. 1 and FIG. 2. As shown in FIG. 5, UCS model 516 may be a submodule to which the performance properties are input. Method 500 proceeds to step 508 whereby the predicted performance properties are compared to a required performance characteristic to determine if the one or more pozzolans are suitable for use in a cement slurry design. Step 508 may include manual review by a cement engineer to determine by experience if the one more pozzolans are suitable. If the determination is made that the one or more pozzolans are suitable, the suitable pozzolans, and optionally their physical and chemical properties are stored in database 518 for reference in future cement slurry designs.

Accordingly, the present disclosure may provide methods and systems for producing a sustainable pipeline of pozzolanic materials. The methods and systems may include any of the various features disclosed herein, including one or more of the following statements.

Statement 1: A method of producing a sustainable pipeline of pozzolanic materials comprising: gathering unstructured and/or structured data publicly available on a network and converting the unstructured data to structured data; identifying analytical data of a pozzolanic material using one or more machine learning models, wherein the analytical data is present within the unstructured and/or structured data; extracting the analytical data from the structured data; predicting, using one or more predictive models, one or more performance characteristics of the pozzolanic material based at least in part on the analytical data, to form one or more predicted performance characteristics; comparing the predicted one or more performance characteristics to one or more minimum acceptable performance characteristics; storing the extracted analytical data and the one or more predicted performance characteristics in a database if the one or more performance characteristics meets or exceeds the minimum acceptable performance characteristic; and preparing a cement composition comprising the pozzolanic material if the predicted one or more performance characteristics meets or exceeds the one or more minimum acceptable performance characteristics.

Statement 2: A method of producing a sustainable pipeline of pozzolanic materials comprising: gathering structured data publicly available on a network; identifying analytical data of a pozzolanic material using one or more machine learning models, wherein the analytical data is present within the structured data; extracting the analytical data from the structured data; predicting, using one or more predictive models, one or more performance characteristics of the pozzolanic material based at least in part on the analytical data, to form one or more predicted performance characteristics; comparing the predicted one or more performance characteristics to one or more minimum acceptable performance characteristics; storing the extracted analytical data and the one or more predicted performance characteristics in a database if the one or more performance characteristics meets or exceeds the minimum acceptable performance characteristic; and preparing a cement composition comprising the pozzolanic material if the predicted one or more performance characteristics meets or exceeds the one or more minimum acceptable performance characteristics.

Statement 3: A method of producing a sustainable pipeline of pozzolanic materials comprising: gathering unstructured data publicly available on a network; converting the unstructured data to structured data; identifying analytical data of a pozzolanic material using one or more machine learning models, wherein the analytical data is present within the structured data; extracting the analytical data from the structured data after the conversion; predicting, using one or more predictive models, one or more performance characteristics of the pozzolanic material based at least in part on the analytical data, to form one or more predicted performance characteristics; comparing the predicted one or more performance characteristics to one or more minimum acceptable performance characteristics; storing the extracted analytical data and the one or more predicted performance characteristics in a database if the one or more performance characteristics meets or exceeds the minimum acceptable performance characteristic; and preparing a cement composition comprising the pozzolanic material if the predicted one or more performance characteristics meets or exceeds the one or more minimum acceptable performance characteristics.

Statement 4: The method of statements 1 or 3, further comprising converting the unstructured data to structured data.

Statement 5: The method of any of statements 1-4 wherein the unstructured and/or structured data comprises at least one source of data selected from the group consisting of: published experimental data; published scientific articles; tabulated pozzolanic material data; documentation containing analytical and/or performance information relating to one or more pozzolanic materials; online pozzolan databases; publicly facing government databases of pozzolanic materials; and any combinations thereof.

Statement 6: The method of any of statements 1-5, wherein the gathering of the unstructured and/or structured data and the storing of the extracted analytical data in the database are both performed on an at least semi-continuous basis.

Statement 7: The method of any of statements 1-6, wherein the one or more machine learning models comprises at least one algorithm type selected from the group consisting of: convolutional neural networks; long short term memory networks; recurrent neural networks; generative adversarial networks; attention neural networks; zero-shot models; fine-tuned models; domain-specific models; multi-modal models; transformer architectures; radial basis function networks; multilayer perceptrons; self-organizing maps; deep belief networks; and combinations thereof.

Statement 8: The method of any of statements 1-7, wherein the analytical data comprises at least one analytical property selected from the group consisting of: specific surface area; water requirement; water retention; oxide content; x-ray diffraction; crystalline silica content; amorphous silica content; morphology; rheology; x-ray fluorescence; particle size; particle size distribution; specific heat; bulk density; heat of reaction; thermal conductivity; heat content; specific surface area; specific gravity; radius of gyration; adsorption; lime content; calcium hydroxide content; silica oxide content; calcium oxide content; aluminum oxide content; sodium oxide content; iron oxide content; sulfur content; iron content; calcium content; sodium content; potassium content; magnesium content; alkali content; mixability; stability; sphericity; dispersing ability; fluid loss control ability; density; reactivity; protein-retention; and any combinations thereof.

Statement 9: The method of any of statements 1-8, wherein the one or more predictive models comprise one or more deterministic equations.

Statement 10: The method of any of statements 1-9, wherein the one or more predictive models comprise one or more machine learning models.

Statement 11: The method of statement 10, wherein the machine learning models are trained to predict performance based on historical cement performance data.

Statement 12: The method of any of statements 1-11, wherein the one or more predictive models comprise an ensemble of machine learning models, each associated at least with identity and/or concentration of at least one of the one or more pozzolanic materials.

Statement 13: The method of any of statements 1-12, wherein at least one of the one or more predictive models is built using a random forest and/or a distributed gradient boosting library.

Statement 14: The method of statement 13, wherein the one or more predictive models is trained on a dataset comprising at least one dataset selected from the group consisting of: performance characteristic of pozzolanic materials; casing logs; bonding logs; material performance data; previously saved; used; or rendered viable cement compositions using different pozzolanic materials; and combinations thereof.

Statement 15: The method of any of statements 1-14, wherein the one or more predicted performance characteristics comprises at least one cement performance characteristic selected from the group consisting of: unconfined compressive strength; tensile strength; young's modulus; Poisson's ratio; thickening time; heat of hydration; extent of reaction; longevity; resistance to carbon dioxide; resistance to corrosion; secant toughness; fracture toughness; a mechanical property; secant toughness; stress-strain; fluid loss; free water content; mixability; a lattice parameter, thermal conductivity; reactivity; and any combination thereof.

Statement 16: A method of producing a sustainable pipeline of pozzolanic materials comprising: training a machine learning model to recognize pozzolanic materials within a document to form a trained machine learning model; training a predictive model to predict a pozzolan performance characteristic, to form a trained predictive model; gathering unstructured and/or structured data publicly available on a network with a web-crawler and converting the unstructured data to structured data; identifying analytical data of a pozzolanic material using the trained machine learning model, wherein the analytical data is present within at least the structured data; extracting the analytical data from the structured data; predicting, using the trained predictive model, one or more performance characteristics of the pozzolanic material based at least in part on the analytical data, to form one or more predicted performance characteristics; comparing the predicted one or more performance characteristics to one or more minimum acceptable performance characteristics; storing the extracted analytical data and the one or more predicted performance characteristics in a database if the one or more performance characteristics meets or exceeds the minimum acceptable performance characteristic; and preparing a cement composition comprising the pozzolanic material if the predicted one or more performance characteristics meets or exceeds the one or more minimum acceptable performance characteristics.

Statement 17: The method of statement 16 wherein the one or more machine learning models comprises at least one algorithm type selected from the group consisting of: convolutional neural networks; long short term memory networks; recurrent neural networks; generative adversarial networks; attention neural networks; zero-shot models; fine-tuned models; domain-specific models; multi-modal models; transformer architectures; radial basis function networks; multilayer perceptrons; self-organizing maps; deep belief networks; and combinations thereof.

Statement 18: The method of statements 16 or 17, wherein the predictive model is trained on a dataset comprising at least one dataset selected from the group consisting of: performance characteristic of pozzolanic materials; casing logs; bonding logs; material performance data; previously saved, used, or rendered viable cement compositions comprising pozzolanic materials; and combinations thereof.

Statement 19: The method of any of statements 16-18, wherein the one or more predictive models comprise one or more machine learning models comprising at least one algorithm type selected from the group consisting of: convolutional neural networks; long short term memory networks; recurrent neural networks; generative adversarial networks; attention neural networks; zero-shot models; fine-tuned models; domain-specific models; multi-modal models; transformer architectures; radial basis function networks; multilayer perceptrons; self-organizing maps; deep belief networks; and combinations thereof.

Statement 20: The method of any of statements 16-19, wherein at least one of the one or more predictive models is built using a random forest and/or a distributed gradient boosting library.

Statement 21: The method of any of statements 16-20, wherein the trained predictive model further comprises an element comprising one or more deterministic equations.

Statement 22: The method of any of statements 16-21, wherein the trained predictive model comprises an ensemble of machine learning models, each associated at least one type of analytical data of the pozzolanic material.

Statement 23: The method of any of statements 16-22, wherein the analytical data comprises at least one analytical property selected from the group consisting of: specific surface area; water requirement; water retention; oxide content; x-ray diffraction; crystalline silica content; amorphous silica content; morphology; rheology; x-ray fluorescence; particle size; particle size distribution; specific heat; bulk density; heat of reaction; thermal conductivity; heat content; specific surface area; specific gravity; radius of gyration; adsorption; lime content; calcium hydroxide content; silica oxide content; calcium oxide content; aluminum oxide content; sodium oxide content; iron oxide content; sulfur content; iron content; calcium content; sodium content; potassium content; magnesium content; alkali content; mixability; stability; sphericity; dispersing ability; fluid loss control ability; density; reactivity; protein-retention; and any combinations thereof.

To facilitate a better understanding of the present invention, the following examples of certain aspects of some embodiments are given. In no way should the following examples be read to limit, or define, the entire scope of the disclosure.

### Example

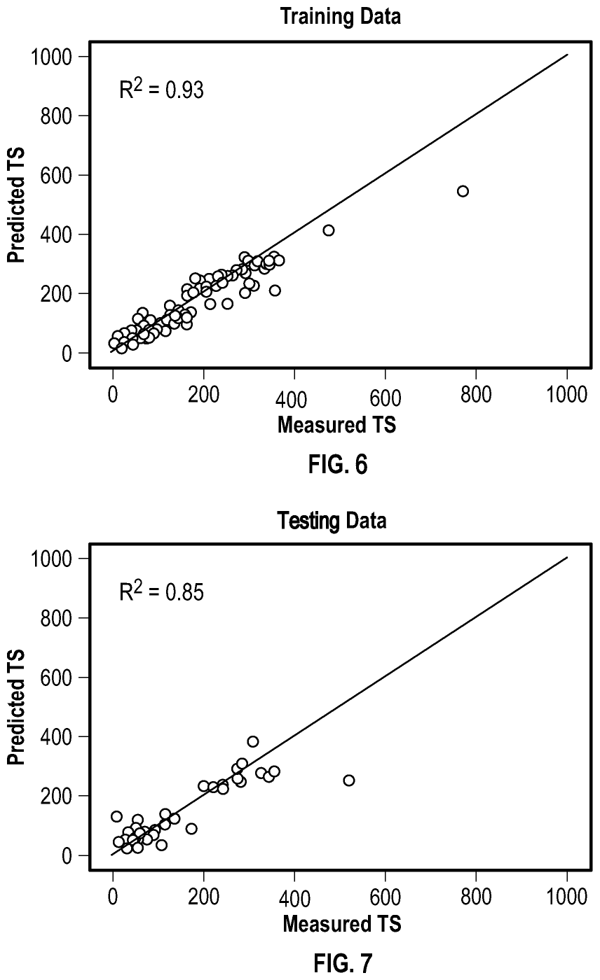

In this example, machine learning models of tensile strength (TS) of various Pozzolanic materials were built using random forest models. These models were built using 278 data points comprising 222 training data points and 56 data points for testing. The analytical factors used in building these models included specific surface area (SSA), water requirement (WR), oxide content, X-ray Diffraction (XRD) data showing amorphous and crystalline content. FIG. 6 is a parity plot of measured tensile strength versus modeled tensile strength for training data. FIG. 7 is a parity plot of measured tensile strength versus modeled tensile strength for testing data. It was observed that the model of TS had a coefficient of determination of 0.85. The model shows enough accuracy to be used in a method to qualify whether the pozzolanic material has an ability to set and develop strength.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. Additionally, whenever a numerical range with a lower limit and an upper limit is disclosed, any number and any included range falling within the range are specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values even if not explicitly recited. Thus, every point or individual value may serve as its own lower or upper limit combined with any other point or individual value or any other lower or upper limit, to recite a range not explicitly recited. Although specific examples have been described above, these examples are not intended to limit the scope of the present disclosure, even where only a single example is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Various advantages of the present disclosure have been described herein, but examples may provide some, all, or none of such advantages, or may provide other advantages.

As used herein, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Therefore, the present embodiments are well adapted to attain the ends and advantages mentioned as well as those that are inherent therein. The particular embodiments disclosed above are illustrative only, as the present embodiments may be modified and practiced in different but equivalent manners apparent to those skilled in the art having the benefit of the teachings herein. Although individual embodiments are discussed, all combinations of each embodiment are contemplated and covered by the disclosure. Furthermore, no limitations are intended to the details of construction or design shown herein, other than as described in the claims below. Also, the terms in the claims have their plain, ordinary meaning unless otherwise explicitly and clearly defined by the patentee. It is therefore evident that the particular illustrative embodiments disclosed above may be altered or modified and all such variations are considered within the scope and spirit of the present disclosure.

What is claimed is:

1. A method of producing a sustainable pipeline of pozzolanic materials comprising:
gathering unstructured and/or structured data publicly available on a network;
identifying analytical data of a pozzolanic material using one or more machine learning models, wherein the analytical data is present within at least the unstructured and/or structured data;
extracting the analytical data from the unstructured and/or structured data;
predicting, using one or more predictive models, one or more performance characteristics of the pozzolanic material based at least in part on the analytical data, to form one or more predicted performance characteristics;
comparing the predicted one or more performance characteristics to one or more minimum acceptable performance characteristics;
storing the extracted analytical data and the one or more predicted performance characteristics in a database if the one or more performance characteristics meets or exceeds the minimum acceptable performance characteristic; and
preparing a cement composition comprising the pozzolanic material if the predicted one or more performance characteristics meets or exceeds the one or more minimum acceptable performance characteristics.

2. The method of claim 1 wherein the unstructured and/or structured data comprises at least one source of data selected from the group consisting of: published experimental data; published scientific articles; tabulated pozzolanic material data; documentation containing analytical and/or performance information relating to one or more pozzolanic materials; online pozzolan databases; publicly facing government databases of pozzolanic materials; and any combinations thereof.

3. The method of claim 1, further comprising converting the unstructured data to structured data, wherein the gathering of the unstructured and/or structured data and the storing of the extracted analytical data in the database are both performed on an at least semi-continuous basis.

4. The method of claim 1, wherein the one or more machine learning models comprises at least one algorithm type selected from the group consisting of: convolutional neural networks; long short term memory networks; recurrent neural networks; generative adversarial networks; attention neural networks; zero-shot models; fine-tuned models; domain-specific models; multi-modal models; transformer architectures; radial basis function networks; multilayer perceptrons; self-organizing maps; deep belief networks; and combinations thereof.

5. The method of claim 1, wherein the analytical data comprises at least one analytical property selected from the group consisting of: specific surface area; water requirement; water retention; oxide content; x-ray diffraction; crystalline silica content; amorphous silica content; morphology; rheology; x-ray fluorescence; particle size; particle size distribution; specific heat; bulk density; heat of reaction; thermal conductivity; heat content; specific surface area; specific gravity; radius of gyration; adsorption; lime content; calcium hydroxide content; silica oxide content; calcium oxide content; aluminum oxide content; sodium oxide content; iron oxide content; sulfur content; iron content; calcium content; sodium content; potassium content; magnesium content; alkali content; mixability; stability; sphericity; dispersing ability; fluid loss control ability; density; reactivity; protein-retention; and any combinations thereof.

6. The method of claim 1, wherein the one or more predictive models comprise one or more deterministic equations.

7. The method of claim 1, wherein the one or more predictive models comprise one or more machine learning models.

8. The method of claim 7, wherein the machine learning models are trained to predict performance based on historical cement performance data.

9. The method of claim 1, wherein the one or more predictive models comprise an ensemble of machine learning models, each associated at least with identity and/or concentration of at least one of the one or more pozzolanic materials.

10. The method of claim 1, wherein at least one of the one or more predictive models is built using a random forest and/or a distributed gradient boosting library.

11. The method of claim 10, wherein the one or more predictive models is trained on a dataset comprising at least one dataset selected from the group consisting of: performance characteristic of pozzolanic materials; casing logs; bonding logs; material performance data; previously saved; used; or rendered viable cement compositions using different pozzolanic materials; and combinations thereof.

12. The method of claim 1, wherein the one or more predicted performance characteristics comprises at least one cement performance characteristic selected from the group consisting of: unconfined compressive strength; tensile strength; young's modulus; Poisson's ratio; thickening time; heat of hydration; extent of reaction; longevity; resistance to carbon dioxide; resistance to corrosion; secant toughness; fracture toughness; a mechanical property; secant toughness; stress-strain; fluid loss; free water content; mixability; a lattice parameter, thermal conductivity; reactivity; and any combination thereof.

13. A method of producing a sustainable pipeline of pozzolanic materials comprising:
training a machine learning model to recognize pozzolanic materials within a document to form a trained machine learning model;
training a predictive model to predict a pozzolan performance characteristic, to form a trained predictive model;
gathering unstructured and/or structured data publicly available on a network with a web-crawler and converting the unstructured data to structured data;
identifying analytical data of a pozzolanic material using the trained machine learning model, wherein the analytical data is present within at least the structured data;
extracting the analytical data from the structured data;
predicting, using the trained predictive model, one or more performance characteristics of the pozzolanic material based at least in part on the analytical data, to form one or more predicted performance characteristics;
comparing the predicted one or more performance characteristics to one or more minimum acceptable performance characteristics;
storing the extracted analytical data and the one or more predicted performance characteristics in a database if the one or more performance characteristics meets or exceeds the minimum acceptable performance characteristic; and
preparing a cement composition comprising the pozzolanic material if the predicted one or more performance characteristics meets or exceeds the one or more minimum acceptable performance characteristics.

14. The method of claim 13 wherein the one or more machine learning models comprise at least one algorithm type selected from the group consisting of: convolutional neural networks; long short term memory networks; recurrent neural networks; generative adversarial networks; attention neural networks; zero-shot models; fine-tuned models; domain-specific models; multi-modal models; transformer architectures; radial basis function networks; multilayer perceptrons; self-organizing maps; deep belief networks; and combinations thereof.

15. The method of claim 13, wherein the predictive model is trained on a dataset comprising at least one dataset selected from the group consisting of: performance characteristic of pozzolanic materials; casing logs; bonding logs; material performance data; previously saved, used, or rendered viable cement compositions comprising pozzolanic materials; and combinations thereof.

16. The method of claim 13, wherein the one or more predictive models comprise at least one algorithm type selected from the group consisting of: convolutional neural networks; long short term memory networks; recurrent neural networks; generative adversarial networks; attention neural networks; zero-shot models; fine-tuned models; domain-specific models; multi-modal models; transformer architectures; radial basis function networks; multilayer perceptrons; self-organizing maps; deep belief networks; and combinations thereof.

17. The method of claim 13, wherein at least one of the one or more predictive models is built using a random forest and/or a distributed gradient boosting library.

18. The method of claim 13, wherein the trained predictive model further comprises an element comprising one or more deterministic equations.

19. The method of claim 13, wherein the trained predictive model comprises an ensemble of machine learning models, each associated at least one type of analytical data of the pozzolanic material.

20. The method of claim 13, wherein the analytical data comprises at least one analytical property selected from the group consisting of: specific surface area; water requirement; water retention; oxide content; x-ray diffraction; crystalline silica content; amorphous silica content; morphology; rheology; x-ray fluorescence; particle size; particle size distribution; specific heat; bulk density; heat of reaction; thermal conductivity; heat content; specific surface area; specific gravity; radius of gyration; adsorption; lime content; calcium hydroxide content; silica oxide content; calcium oxide content; aluminum oxide content; sodium oxide content; iron oxide content; sulfur content; iron content; calcium content; sodium content; potassium content; magnesium content; alkali content; mixability; stability; sphericity; dispersing ability; fluid loss control ability; density; reactivity; protein-retention; and any combinations thereof.
